(19) United States
(12) Patent Application Publication
(10) Pub. No.: US 2009/0234065 A1
(43) Pub. Date: Sep. 17, 2009

(54) INK SET FOR INKJET RECORDING

(75) Inventor: Misato SASADA, Ashigarakami-gun (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM CORPORATION, Tokyo (JP)

(21) Appl. No.: 12/400,305

(22) Filed: Mar. 9, 2009

(30) Foreign Application Priority Data
Mar. 13, 2008 (JP) 2008-064544

(51) Int. Cl. C08L 31/02

(52) U.S. Cl. 524/558

(57) ABSTRACT

An ink set for inkjet recording including: a cyan color aqueous ink composition containing a cyan color pigment, an organic solvent, a neutralizing agent and water, a magenta color aqueous ink composition containing a magenta color pigment, an organic solvent, a neutralizing agent and water, and a yellow color aqueous ink composition containing a yellow color pigment, an organic solvent, a neutralizing agent and water, wherein the cyan color pigment, the magenta color pigment, and the yellow color pigment are each a pigment coated with a water-insoluble resin containing a structural unit represented by the following Formula (I):

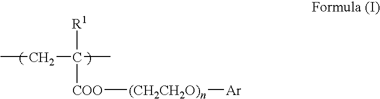

wherein R¹ represents a hydrogen atom or a methyl group, Ar represents an unsubstituted or substituted aromatic ring, and n represents an average repeating number and is from 1 to 6.

### CROSS-REFERENCE TO RELATED APPLICATION

This application claims priority under 35 USC 119 from Japanese Patent Application No. 2008-064544, the disclosure of which is incorporated by reference herein.

### BACKGROUND OF THE INVENTION

1. Field of the Invention

The present invention relates to an ink set for inkjet recording including a plurality of aqueous ink compositions.

2. Description of the Related Art

For recording media for inkjet recording and inks used therewith, techniques for obtaining high quality recorded materials excellent in coloring density, fixability, and resolution have extensively been examined.

As colorants used in inkjet recording inks, pigments are widely used from the viewpoint of light resistance and water resistance. As recording liquids for inkjet printers, an ink set having a cyan color ink, a magenta color ink and a yellow color ink, or an ink set having a black color ink in addition to these inks, has been used in color image recording.

When an ink is adhered near a nozzle of an inkjet recording apparatus, and another ink is used which is different significantly from the ink in composition, a mixed aggregate tends to be caused, which may result in nozzle clogging and insufficient ink ejection.

As a technique related to the foregoing description, an ink set for inkjet recording wherein colorants are contained in water dispersions of the same or similar water-insoluble vinyl polymer particles is disclosed as an ink set with low viscosity that provides excellent ejection stability and color reproduction range (for example, Japanese Patent Application Laid-Open (JP-A) No. 2005-29598).

However, when a plurality of inks is included in an ink set, dispersants used in the inks having the respective colors are often different from one another, and when dispersants in the inks having the respective colors constituting an ink set are significantly different from one another, aggregation and uneven gloss are brought about, thus causing a problem of difficult formation of high-quality images.

When pigments used as the colorants in conventional methods are used, images after recording are poor in scratch resistance.

Further, when images are recorded, a mist generated during ejection of droplets causes failure in ejection directionality resulting from, for example, adhesion and drying of an aggregate formed by mixing of a plurality of liquids near a head. Since the aggregate is not removed by newly ejected liquids, and removability of the adhered aggregate (that is, maintainability) is not sufficient, there is a problem of causing troubles such as white spots in recorded images.

### SUMMARY OF THE INVENTION

According to an aspect of the invention, there is provided an ink set for inkjet recording comprising:

a cyan color aqueous ink composition containing a cyan color pigment, an organic solvent, a neutralizing agent and water,

a magenta color aqueous ink composition containing a magenta color pigment, an organic solvent, a neutralizing agent and water, and

a yellow color aqueous ink composition containing a yellow color pigment, an organic solvent, a neutralizing agent and water,

wherein the cyan color pigment, the magenta color pigment, and the yellow color pigment are each a pigment coated with a water-insoluble resin containing a structural unit represented by the following Formula (I):

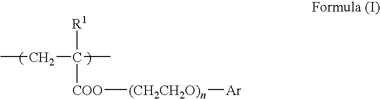

wherein R¹ represents a hydrogen atom or a methyl group, Ar represents an unsubstituted or substituted aromatic ring, and n represents an average repeating number and is from 1 to 6.

### DETAILED DESCRIPTION OF THE INVENTION

Hereinafter, the ink set for inkjet recording of the invention is described in detail.

The ink set for inkjet recording of the invention comprises at least three (cyan color, magenta color and yellow color) aqueous ink compositions, wherein the three (cyan color, magenta color and yellow color) pigments in the respective inks are each coated with an water-insoluble resin containing a structural unit represented by Formula (I) below. In the invention, all or part of the pigments contained in one aqueous ink composition (for example, the cyan color aqueous ink composition) may be coated with the water-insoluble resin in the invention.

Preferably, the ink set of the invention further comprises a black color aqueous ink composition, and a carbon black contained in this aqueous ink composition is coated with the water-insoluble resin containing a structural unit represented by Formula (I) below.

In the invention, since the resins which are used in the aqueous ink compositions of the respective colors and exhibit a dispersing function by adhering to the pigment have similar structures, when forming color images, it is possible to prevent aggregation due to contact between the aqueous ink compositions, unevenness of the image and a reduction in scratch resistance.

The ink set of the invention may optionally further include an aqueous ink composition of another hue, such as red, green and blue. For the same reason as described above, the pigment contained in the aqueous ink composition of another hue is also preferably coated with a water-insoluble resin containing a structural unit of Formula (I) below.

Aqueous Ink Composition

Each of the aqueous ink compositions included in the ink set for inkjet recording of the invention comprises a cyan color pigment, a magenta color pigment, or a yellow color pigment (or a carbon black or another pigment) which is coated with a water-insoluble resin containing a structural unit represented by Formula (I) below (hereinafter referred to sometimes as “resin-coated pigment(s)”), an organic solvent, a neutralizing agent and water. The aqueous ink composition may optionally further comprise other components such as resin fine particles, a polymer latex and a surfactant.

In the invention, in all of the cyan color aqueous ink composition, the magenta color aqueous ink composition, the yellow color aqueous ink composition, and optionally the black color aqueous ink composition included in the ink set, pigments contained as colorants are each coated with a water-insoluble resin containing a structural unit of Formula (I) below and allowed to be present in the ink liquids. Since the pigments are each coated with a resin having a similar structure and stably dispersed, the scratch resistance of recorded images may be improved, the adhesion or accumulation, onto liquid discharging portions, of the aggregate generated by contact between the aqueous ink compositions during recording may be reduced, and the aggregate may be easily removed when adhered to the liquid discharging portions. Images with enhanced film strength and resistance to detachment may thereby be obtained, a failure in ink ejection directionality upon ink ejection may be prevented, and consequently image defects such as white spots may be prevented, thereby realizing higher resolution of images. The frequency of maintenance of an ejection apparatus may be reduced and maintainability may be improved.

—Resin-Coated Pigment—

Each of the aqueous ink compositions included in the ink set of the invention contains at least one kind of pigment (resin-coated pigment) selected depending on the hue from the pigments (including a cyan color pigment, a magenta color pigment, a yellow color pigment and if necessary a carbon black and if necessary pigments of other hues) which is coated with a water-insoluble resin containing a structural unit represented by Formula (I) below (hereinafter referred to sometimes as “the water-insoluble resin in the invention”). In the invention, all of the cyan color, magenta color and yellow color pigments are coated with the same water-insoluble resin, thereby preventing image defects such as white dots in recording color images and improving the scratch resistance of recorded images.

The whole surface of the resin-coated pigment in the invention may not necessarily be coated with the water-insoluble resin in the invention, and depending on the case, at least a part of the pigment surface may be coated therewith.

<Structural Unit Represented by Formula (I)>

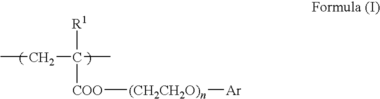

In Formula (I), R¹ represents a hydrogen atom or a methyl group, and preferably a methyl group.

Ar represents an unsubstituted or substituted aromatic ring. When the aromatic ring is substituted with a substituent, examples of the substituent include, for example, a halogen atom, an alkyl group, an alkoxy group, a hydroxyl group and a cyano group, and the aromatic ring may form a condensed ring. When the aromatic ring forms a condensed ring, the condensed ring may be, for example, a condensed aromatic ring having 8 or more carbon atoms, an aromatic ring having a heterocycle condensed therein, or two or more aromatic rings linked to each other.

The “condensed aromatic ring having 8 or more carbon atoms” may be an aromatic ring having two or more benzene rings condensed therein or an aromatic ring having 8 or more carbon atoms composed of at least one aromatic ring and a ring formed by an alicyclic hydrocarbon condensed with the aromatic ring. Specific examples include naphthalene, anthracene, fluorene, phenanthrene, and acenaphthene.

The “aromatic ring having a heterocycle condensed therein” is a compound consisting of a heteroatom-free aromatic compound (preferably a benzene ring) condensed with a heteroatom-containing cyclic compound. The heteroatom-containing cyclic compound is preferably a five- or six-membered ring. The heteroatom is preferably a nitrogen atom, an oxygen atom or a sulfur atom. The heteroatom-containing cyclic compound may have a plurality of heteroatoms. In this case, the heteroatoms may be the same or different. Specific examples of the aromatic ring having a heterocycle condensed therein include phthalimide, acridone, carbazole, benzoxazole, and benzothiazole.

The aromatic ring represented by Ar is linked via an ester group and an ethylene oxide chain to the main chain of the water-insoluble resin, and the aromatic ring is not directly linked to the main chain, and thus a suitable distance is maintained between the hydrophobic aromatic ring and the hydrophilic structural unit, so that the water-insoluble resin interacts readily with, and is adsorbed firmly onto, a pigment to improve dispersibility.

In particular, Ar is preferably an unsubstituted benzene ring or an unsubstituted naphthalene ring, and particularly preferably an unsubstituted benzene ring.

n is the average repeating number of the ethylene oxide chain in the water-insoluble resin in the resin-coated pigment contained in the aqueous ink composition. n is in the range of 1 to 6, preferably 1 to 2.

Specific examples of monomers for forming the structural unit represented by Formula (I) include phenoxyethyl(meth)acrylates and the like, and the following monomers:

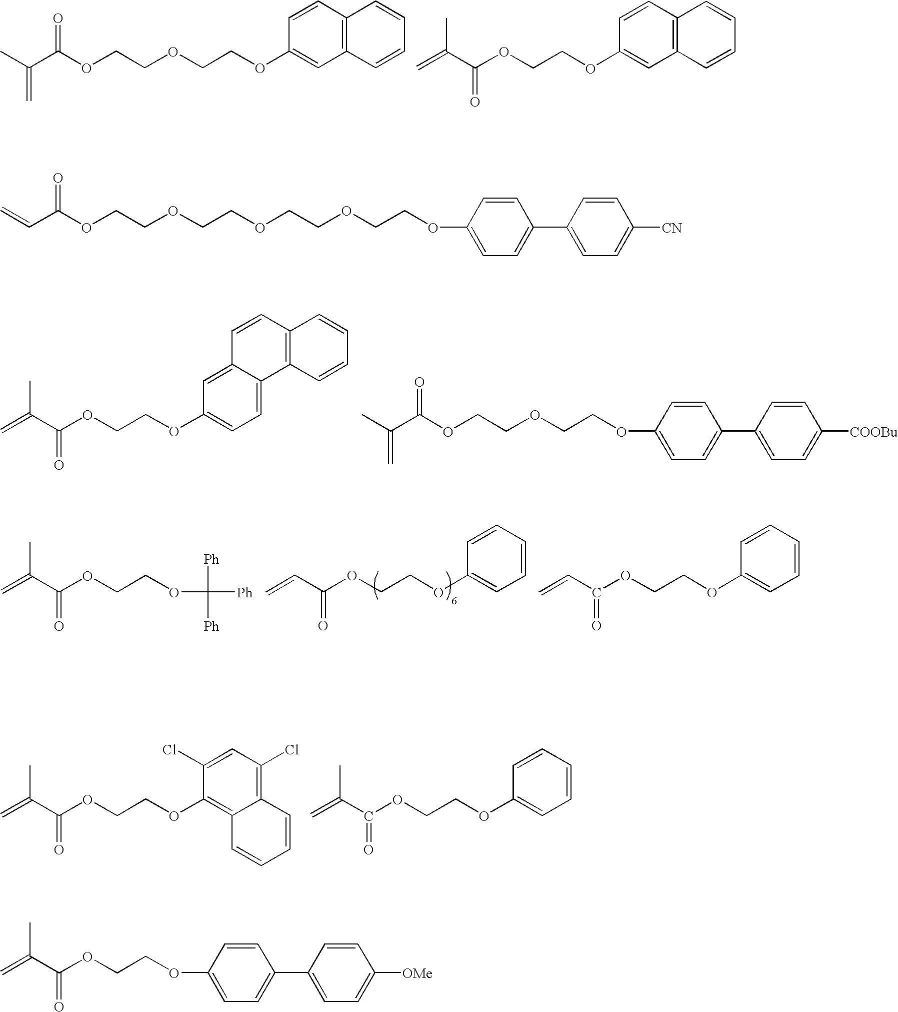

From the viewpoint of dispersion stability, it is particularly preferable that in the structural unit represented by Formula (I), R¹ is a methyl group, Ar is an unsubstituted benzene ring, and n is 1 to 2.

The content of the structural unit of Formula (I) in the water-insoluble resin is preferably in the range of 30 to 70% by mass, and more preferably in the range of 40 to 50% by mass, based on the total mass of the water-insoluble resin. When this content is 30% by mass or more, dispersibility is good, and when the content is 70% by mass or less, the adhesion and deposition of the aggregate may be prevented, the removability of adhered aggregate (maintainability) is good, and imaging troubles such as white spots may be prevented.

The water-insoluble resin in the invention is preferably a resin including a hydrophilic structural unit (A) and a hydrophobic structural unit (B), from the viewpoint of allowing the water-insoluble resin to be stably present in an aqueous ink, to reduce adhesion or deposition of the aggregate, and to facilitate removal of the adhered aggregate. The hydrophobic structural unit (B) includes the structural unit represented by Formula (I) above.

<Hydrophilic Structural Unit (A)>

Preferably, the hydrophilic structural unit (A) is for example a structural unit derived from acrylic acid or methacrylic acid, and the water-insoluble resin preferably contains a structural unit derived from acrylic acid and/or a structural unit derived from methacrylic acid. Other examples of the hydrophilic structural unit (A) include structural units derived from monomers having a nonionic hydrophilic group, and examples include hydrophilic functional group-containing vinyl monomers such as hydrophilic functional group-containing (meth)acrylates, (meth)acrylamides, and vinyl esters.

Examples of the “hydrophilic functional group” include a hydroxyl group, an amino group, an amide group (whose nitrogen atom is unsubstituted), and alkylene oxides such as polyethylene oxide and polypropylene oxide described later.

The monomer for forming a hydrophilic structural unit having a nonionic hydrophilic group may be selected from known monomers and is not particularly limited as long as it has both a functional group such as an ethylenically unsaturated bond capable of forming a polymer and a nonionic hydrophilic functional group. Specific examples preferably include hydroxyethyl(meth)acrylate, hydroxybutyl(meth)acrylate, (meth)acrylamide, aminoethyl acrylate, aminopropyl acrylate, and alkylene oxide polymer-containing (meth)acrylates.

The hydrophilic structural unit (A) having a nonionic hydrophilic group may be formed by polymerization of a corresponding monomer or by introducing a hydrophilic functional group to a polymer chain after polymerization.

The hydrophilic structural unit having a nonionic hydrophilic group is more preferably a hydrophilic structural unit having an alkylene oxide structure. From the viewpoint of hydrophilicity, the alkylene moiety in the alkylene oxide structure is preferably an alkylene moiety having 1 to 6 carbon atoms, more preferably an alkylene moiety having 2 to 6 carbon atoms, and still more preferably an alkylene moiety having 2 to 4 carbon atoms. The degree of polymerization of the alkylene oxide structure is preferably 1 to 120, more preferably 1 to 60, and still more preferably 1 to 30.

In a preferable aspect, the hydrophilic structural unit having a nonionic hydrophilic group is a hydroxyl group-containing hydrophilic structural unit. The number of hydroxyl groups in the structural unit is not particularly limited and is preferably 1 to 4, more preferably 1 to 3, and still more preferably 1 to 2, from the viewpoint of the hydrophilicity of the water-insoluble resin and compatibility with a solvent and other monomers at the time of polymerization.

In the foregoing description, the content of the hydrophilic structural unit varies for example depending on the ratio of the hydrophobic structural unit (B) described later. For example, when the water-insoluble resin is composed of acrylic acid and/or methacrylic acid (hydrophilic structural unit (A)) and the hydrophobic structural unit (B) described later, the content of acrylic acid and/or methacrylic acid is determined by “100−(% by mass of the hydrophobic structural unit)”.

The hydrophilic structural units (A) may be used alone or as a mixture of two or more thereof.

<Hydrophobic Structural Unit (B)>

The water-insoluble resin in the invention may further include, as a hydrophobic structural unit (B), other hydrophobic structural units than the structural unit represented by Formula (I). The other hydrophobic structural units include, for example, structural units derived from (meth)acrylates, (meth)acrylamides, styrenes and vinyl monomers such as vinyl esters which have no hydrophilic functional group and do not belong to the hydrophilic structural unit (A), and a hydrophobic structural unit having an aromatic ring linked via a linking group to an atom included in the main chain of the water-insoluble resin. These structural units may be used alone or as a mixture of two or more thereof.

The (meth)acrylates include, for example, methyl(meth)acrylate, ethyl(meth)acrylate, butyl(meth)acrylate, isobutyl(meth)acrylate and hexyl(meth)acrylate, among which methyl(meth)acrylate, ethyl(meth)acrylate and butyl(meth)acrylate are preferable, and particularly methyl(meth)acrylate and ethyl(meth)acrylate are preferable.

The (meth)acrylamides include, for example, (meth)acrylamides such as N-cyclohexyl(meth)acrylamide, N-(2-methoxyethyl) (meth)acrylamide, N,N-diallyl(meth)acrylamide and N-allyl(meth)acrylamide.

The styrenes include, for example, styrene, methylstyrene, dimethylstyrene, trimethylstyrene, ethylstyrene, isopropylstyrene, n-butylstyrene, tert-butylstyrene, methoxystyrene, butoxystyrene, acetoxystyrene, chlorostyrene, dichlorostyrene, bromostyrene, chloromethylstyrene, hydroxystyrene protected with a group (for example t-Boc or the like) capable of deprotection with an acidic substance, methyl vinyl benzoate, α-methylstyrene and vinyl naphthalene, among which styrene and α-methylstyrene are preferable.

The vinyl esters include, for example, vinyl esters such as vinyl acetate, vinyl chloroacetate, vinyl propionate, vinyl butyrate, vinyl methoxy acetate and vinyl benzoate, among which vinyl acetate is preferable.

In the hydrophobic structural unit having an aromatic ring linked via a linking group to an atom included in the main chain of the water-insoluble resin, the aromatic ring is linked via a linking group to (that is, not directly to) an atom included in the main chain of the water-insoluble resin, so that a suitable distance is maintained between the hydrophobic aromatic ring and the hydrophilic structural unit, thus readily generating interaction between the water-insoluble resin and the pigment thereby bringing about strong adsorption to improve dispersibility.

Examples of the “hydrophobic structural unit having an aromatic ring linked via a linking group to an atom included in the main chain of the water-insoluble resin” preferably include a structural unit represented by the following Formula (II) (excluding a structural unit represented by Formula (I)).

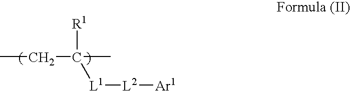

In Formula (II) above, R¹ represents a hydrogen atom, a methyl group or a halogen atom.

L¹ represents *—COO—, *—OCO—, *—CONR²—, *—O—, or a substituted or unsubstituted phenylene group, R² represents a hydrogen atom or an alkyl group having 1 to 10 carbon atoms. The symbol * in the group represented by L¹ represents a linking site linked to the main chain. When the phenylene group is substituted with a substituent, examples of the substituent are not particularly limited and include, for example, a halogen atom, an alkyl group, an alkoxy group, a hydroxyl group, and a cyano group.

L² represents a single bond or a divalent linking group having 1 to 30 carbon atoms, and when L² is a divalent linking group, the linking group is preferably a linking group having 1 to 25 carbon atoms, more preferably a linking group having 1 to 20 carbon atoms, and still more preferably a linking group having 1 to 15 carbon atoms.

Particularly preferable examples of the linking group include an alkyleneoxy group having 1 to 25 carbon atoms (more preferably 1 to 10 carbon atoms), an imino group (—NH—), a sulfamoyl group, a divalent linking group including an alkylene group such as an alkylene group having 1 to 20 carbon atoms (more preferably 1 to 15 carbon atoms) and an ethylene oxide group [—(CH₂CH₂O)ₙ—, n=1 to 6], and a combination of two or more thereof.

In Formula (II), Ar¹ represents a monovalent group derived from an aromatic ring.

The aromatic ring represented by Ar¹ is not particularly limited, and preferable examples include a benzene ring, a condensed aromatic ring having 8 or more carbon atoms, an aromatic ring having a heterocycle condensed therein, and two or more benzene rings linked to each other. The condensed aromatic ring having 8 or more carbon atoms and the aromatic ring having a heterocycle condensed therein are previously described in detail.

Hereinafter, specific examples of monomers capable of forming the hydrophobic structural unit (B) are shown. However, the invention is not limited to the following examples.

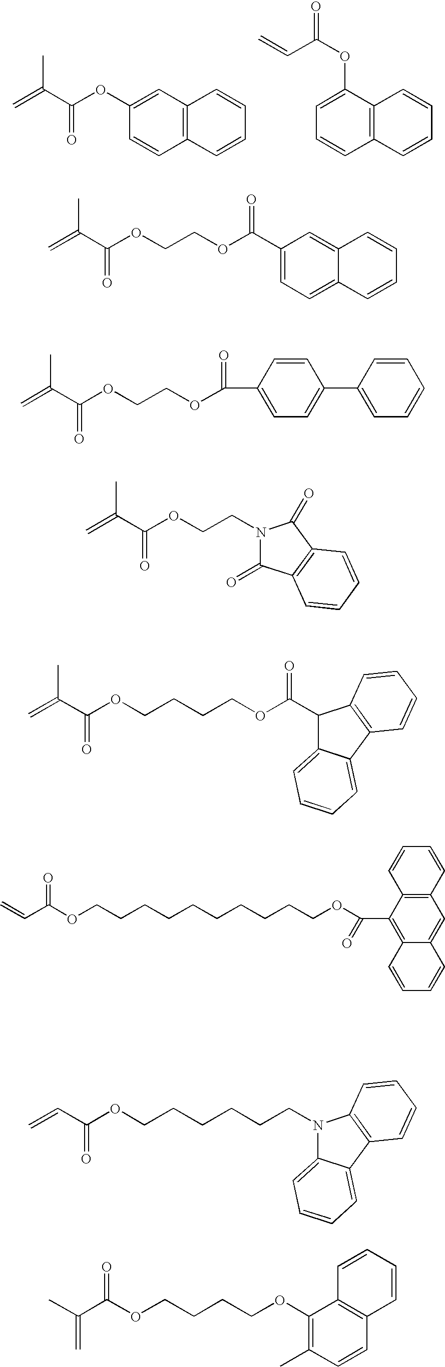

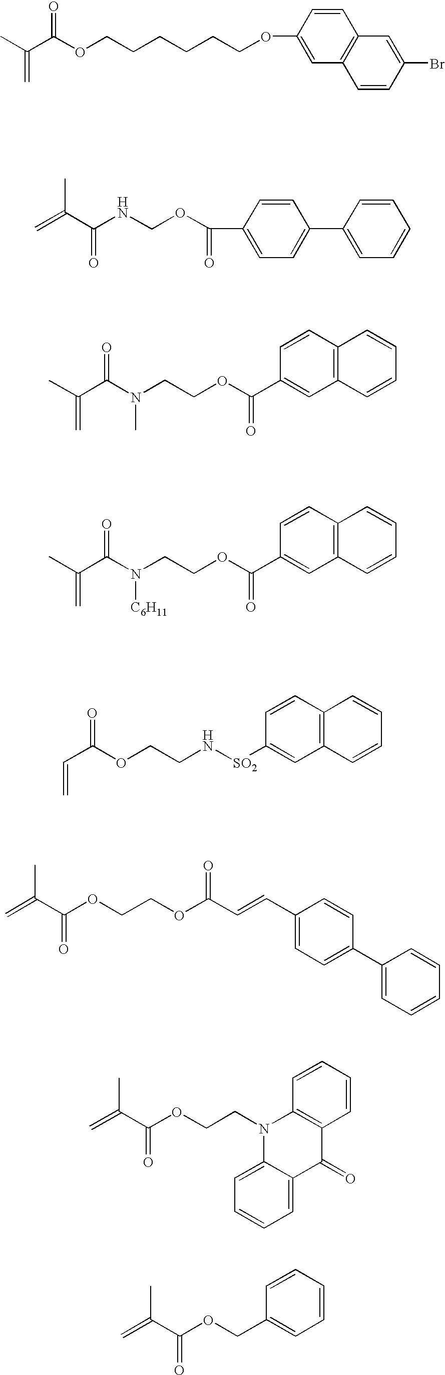

Although the composition of the hydrophilic structural unit (A) and the hydrophobic structural unit (B) (including the structural unit represented by Formula (I)) in the water-insoluble resin in the invention may vary depending on the degrees of their hydrophilicity and hydrophobicity, the content of the hydrophilic structural unit (A) in the resin is preferably 15% by mass or less. At this time, the hydrophobic structural unit (B) is contained in an amount of preferably more than 80% by mass, more preferably 85% by mass or more, based on the total mass of the water-insoluble resin.

When the content of the hydrophilic structural unit (A) is 15% by mass or less, the amount of the component dissolved by itself in an aqueous medium is reduced, various performances such as pigment dispersibility are improved, and excellent ink ejection may be achieved during inkjet recording.

The content of the hydrophilic structural unit (A) is preferably more than 0% by mass but 15% by mass or less, more preferably in the range of 2 to 15% by mass, still more preferably in the range of 5 to 15% by mass, and further more preferably in the range of 8 to 12% by mass, based on the total mass of the water-insoluble resin.

The content of aromatic rings in the water-insoluble resin is preferably 27% by mass or less, more preferably 25% by mass or less, even more preferably 20% by mass or less, based on the total mass of the water-insoluble resin. In particular, the content is preferably in the range of 15 to 20% by mass, and more preferably 17 to 20% by mass. When the content of aromatic rings is in the range defined above, scratch resistance is improved.

From the viewpoint of pigment dispersibility and storage stability, the acid value of the water-insoluble resin in the invention is preferably 30 mg KOH/g or more but 100 mg KOH/g or less, more preferably 30 mg KOH/g or more but 85 mg KOH/g or less, even more preferably 50 mg KOH/g or more but 85 mg KOH/g or less.

The acid value is defined as the mass (mg) of KOH needed to completely neutralize 1 g of the water-insoluble resin and is measured by a method described in JIS Standards (JIS K 0070, 1992), the disclosure of which is incorporated by reference herein,

The weight-average molecular weight (Mw) of the water-insoluble resin in the invention is preferably 30,000 or more, more preferably 30,000 to 150,000, still more preferably 30,000 to 100,000, and further more preferably 30,000 to 80,000. When the molecular weight is 30,000 or more, the steric repulsion effect thereof as a dispersant tends to be improved, thus attaining easy adsorption onto the pigment via the steric effect.

The number-average molecular weight (Mn) of the water-insoluble resin is preferably in the range of 1,000 to 100,000, and more preferably in the range of 3,000 to 50,000. When the number-average molecular weight is in the range defined above, the water-insoluble resin may function as a coating film on the pigment or function as a coating film of the ink composition. The water-insoluble resin in the invention is used preferably in the form of an alkali metal salt or an organic amine salt.

The molecular-weight distribution (weight-average molecular weight/number-average molecular weight) of the water-insoluble resin in the invention is preferably in the range of 1 to 6, and more preferably in the range of 1 to 4. When the molecular-weight distribution is in the range defined above, the dispersion stability and ejection stability of the ink may be improved.

The number-average molecular weight and weight-average molecular weight are determined by gel permeation chromatography (GPC). In GPC, three columns of TSKgel SUPER MULTIPORE HZ-H (trade name, manufactured by Tosoh Corporation, 4.6 mmID×15 cm) are used in HLC-8020 GPC (trade name, manufactured by Tosoh Corporation) with THF (tetrahydrofuran) as eluent and polystyrene as standard to determine the molecular weight. The conditions are as follows: the sample concentration, 0.35% by mass; flow rate, 0.35 ml/min; the sample injection volume, 10 μl; the measurement temperature, 40° C.; and detection, IR detector. A calibration curve is prepared from 8 samples of “Standard Sample TSK standard, polystyrene” manufactured by Tosoh Corporation: “F-40”, “F-20”, “F-4”, “F-1”, “A-5000”, “A-2500”, “A-1000”, and “n-propyl benzene”.

The water-insoluble resin in the invention may be synthesized by various polymerization methods, for example, solution polymerization, precipitation polymerization, suspension polymerization, precipitation polymerization, bulk polymerization and emulsion polymerization. The polymerization reaction may be carried out in known procedures such as batch system, semicontinuous system, and continuous system. Examples of the method of initiating polymerization include a method of using a radical initiator and a method of applying rays or radiations. The polymerization method and the method of initiating polymerization are described in, for example, “Kobunshi Gosei Hoho (Polymer Synthesis Method)”, revised edition, Sadaji Tsuruta (published by Nikkan Kogyo Shimbun, 1971) and “Kobunshi Gosei no Jikken-ho (Experimental Methods for Polymer Synthesis), pp. 124-154, collaborated by Takayuki Otsu and Masaetsu Kinoshita (published by Kagaku Dojin, 1972).

The polymerization method is particularly preferably a solution polymerization method using a radical polymerization initiator. Examples of the solvent used in the solution polymerization method include, for example, various organic solvents such as ethyl acetate, butyl acetate, acetone, methyl ethyl ketone, methyl isobutyl ketone, cyclohexanone, tetrahydrofuran, dioxane, N,N-dimethylformamide, N,N-dimethylacetamide, benzene, toluene, acetonitrile, methylene chloride, chloroform, dichloroethane, methanol, ethanol, 1-propanol, 2-propanol, and 1-butanol. The solvents may be used alone, in combination of two or more thereof, or as a mixed solvent with water. The polymerization temperature should be established in connection with the molecular weight of a polymer formed, the type of an initiator and the like, and usually is about 0° C. to 100° C., and preferably the polymerization is conducted in the range of 50 to 100° C. The reaction pressure may be appropriately selected, and is usually 1 to 100 kg/cm², more preferably about 1 to 30 kg/cm². The reaction time may be about 5 to 30 hours. The obtained resin may be purified by re-precipitation or the like.

Preferable examples of the water-insoluble resin in the invention are shown below. However, the invention is not limited to those shown below. Lower right numerical values assigned to round brackets in B-11 to B-13 refer to % by mass.

| | | |
|---|---|---|
| 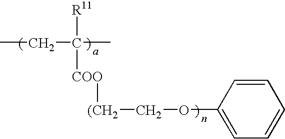 | 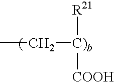 | 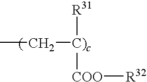 |

(a, b and c represent the respective composition ratios (% by mass).)

| | R¹¹ | n | R²¹ | R³¹ | R³² | a | b | c | Mw |
|---|---|---|---|---|---|---|---|---|---|
| B-1 | CH₃ | 1 | CH₃ | CH₃ | —CH₃ | 60 | 9 | 31 | 35500 |
| B-2 | H | 1 | H | H | —CH₂CH₃ | 69 | 10 | 21 | 41200 |
| B-3 | CH₃ | 2 | CH₃ | CH₃ | —CH₃ | 70 | 11 | 19 | 68000 |
| B-4 | CH₃ | 4 | CH₃ | CH₃ | —CH(CH₃)CH₃ | 70 | 7 | 23 | 72000 |
| B-5 | H | 5 | H | H | —CH₃ | 70 | 10 | 20 | 86000 |
| B-6 | H | 5 | H | H | —CH₂CH(CH₃)CH₃ | 70 | 2 | 28 | 42000 |
| B-7 | CH₃ | 1 | CH₃ | CH₃ | —CH₂CH₃ | 50 | 11 | 39 | 44500 |
| B-8 | CH₃ | 1 | CH₃ | CH₃ | —CH₂CH₃ | 50 | 10 | 40 | 51200 |
| B-9 | H | 1 | H | H | —CH₂CH₃ | 45 | 11 | 44 | 48900 |
| B-10 | H | 1 | CH₃ | CH₃ | —CH₂CH₃ | 45 | 12 | 43 | 43600 |

| | | | | Mw |
|---|---|---|---|---|
| B-11 | 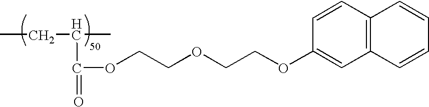 | 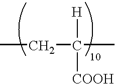 | 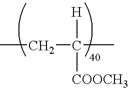 | 72400 |
| B-12 | 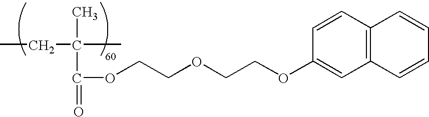 | 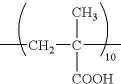 | 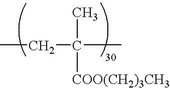 | 33800 |
| B-13 | 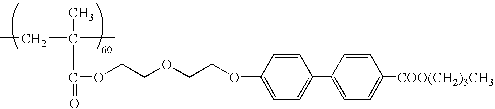 | 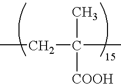 | 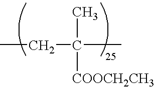 | 39200 |

<Pigment>

Now, the pigment to be coated with the water-insoluble resin in the invention is described.

The pigment is not particularly limited, may be appropriately selected depending on the object, and may be for example either an organic or inorganic pigment.

Examples of the organic pigment include, for example, azo pigments, polycyclic pigments, dye chelates, nitro pigments, nitroso pigments, aniline black, and the like. Among them, azo pigments and polycyclic pigments are more preferable.

The azo pigments include, for example, azo lakes, insoluble azo pigments, condensed azo pigments, chelate azo pigments, and the like

The polycyclic pigments include, for example, phthalocyanine pigments, perylene pigments, perinone pigments, anthraquinone pigments, quinacridone pigments, dioxazine pigments, indigo pigments, thioindigo pigments, isoindolinone pigments, quinophthalone pigments, and the like.

The dye chelates include, for example, basic dye chelates, acidic dye chelates, and the like.

As the organic pigments, yellow ink (yellow color) pigments include, for example, C.I. Pigment Yellow, 1, 2, 3, 4, 5, 6, 7, 10, 11, 12, 13, 14, 14C, 16, 17, 24, 34, 35, 37, 42, 53, 55, 65, 73, 74, 75, 81, 83, 93, 95, 97, 98, 100, 101, 104, 108, 109, 110, 114, 117, 120, 128, 129, 138, 150, 151, 153, 154, 155, 180, and the like.

Magenta ink (magenta color) pigments include, for example, C.I. Pigment Red 1, 2, 3, 4, 5, 6, 7, 8, 9, 10, 11, 12, 13, 14, 15, 16, 17, 18, 19, 21, 22, 23, 30, 31, 32, 37, 38, 39, 40, 48 (Ca), 48 (Mn), 48:2, 48:3, 48:4, 49, 49:1, 50, 51, 52, 52:2, 53:1, 53, 55, 57 (Ca), 57:1, 60, 60:1, 63:1, 63:2, 64, 64:1, 81, 83, 87, 88, 89, 90, 101 (colcothar), 104, 105, 106, 108 (cadmium red), 112, 114, 122 (quinacridone magenta), 123, 146, 149, 163, 166, 168, 170, 172, 177, 178, 179, 184, 185, 190, 193, 202, 209, 219, 269 and the like, and C.I. Pigment Violet 19, among which C.I. Pigment Red 122 is particularly preferable.

Cyan ink (cyan color) pigments include, for example, C.I. Pigment Blue 1, 2, 3, 15, 15:1, 15:2, 15:3, 15:34, 16, 17:1, 22, 25, 56, 60, C.I. Vat Blue 4, 60, 63, and the like, among which C.I. Pigment Blue 15:3 is particularly preferable.

The inorganic pigments include, for example, titanium oxide, iron oxide, calcium carbonate, barium sulfate, aluminum hydroxide, barium yellow, cadmium red, chromium yellow, carbon black, and the like. Among them, carbon black is particularly preferable. Examples of carbon black include those produced by methods known in the art, such as a contact method, a furnace method and a thermal method.

Specific examples of carbon black as the black pigment include, but are not limited to, Raven 7000, Raven 5750, Raven 5250, Raven 5000 ULTRAII, Raven 3500, Raven 2000, Raven 1500, Raven 1250, Raven 1200, Raven 1190 ULTRAII, Raven 1170, Raven 1255, Raven 1080, Raven 1060, and Raven 700 (manufactured by Columbian Carbon); Regal 400R, Regal 330R, Regal 660R, Mogul L, Black Pearls L, Monarch 700, Monarch 800, Monarch 880, Monarch 900, Monarch 1000, Monarch 1100, Monarch 1300, and Monarch 1400 (manufactured by Cabot); Color Black FW1, Color Black FW2, Color Black FW2V, Color Black 18, Color Black FW200, Color Black S150, Color Black S160, Color Black S170, Printex 35, Printex U, Printex V, Printex 140U, Printex 140V, Special Black 6, Special Black 5, Special Black 4A, and Special Black 4 (manufactured by Degussa); No. 25, No. 33, No. 40, No. 45, No. 47, No. 52, No. 900, No. 2200B, No. 2300, MCF-88, MA600, MA7, MA8, and MA100 (manufactured by Mitsubishi Chemical Corp.); and the like.

The pigments may be used alone or as a mixture of pigments selected from one or more groups described above.

The weight ratio (p:r) of the pigment (p) and the water-insoluble resin (r) in the invention is preferably from 100:25 to 100:140, and more preferably from 100:25 to 100:50. When the ratio (p:r) is 100:25 or more, dispersion stability and scratch resistance tend to be improved. When the ratio (p:r) is 100:140 or less, dispersion stability tends to be improved.

The resin-coated pigment (capsulated pigment) in the invention may be produced from the water-insoluble resin, the pigment, and the like by conventional physical or chemical methods. The resin-coated pigment may be produced by methods described in, for example, JP-A No. 9-151342, JP-A No. 10-140065, JP-A No. 11-209672, JP-A No. 11-172180, JP-A No. 10-25440 and JP-A No. 11-43636. Specific examples of such methods include a phase inversion emulsification method and an acid precipitation method described in JP-A No. 9-151342 and JP-A No. 10-140065, and particularly the phase inversion emulsification method is preferable from the viewpoint of dispersion stability.

a) Phase Inversion Emulsification Method

The phase inversion emulsification method is basically a self-dispersion (phase inversion emulsification) method including dispersing, in water, a mixed melt of a pigment and a resin having a self-dispersion ability or solubility. The mixed melt may contain a curing agent or a polymer compound. Herein, the mixed melt encompasses melts in an undissolved and mixed state and/or in a dissolved and mixed state. Specifically, a method described in JP-A No. 10-140065 may be referred to as the “phase inversion emulsification method”.

b) Acid Precipitation Method

The acid precipitation method is a method wherein a water-containing cake consisting of a resin and a pigment is prepared, and anionic groups of the resin in the water-containing cake are partially or wholly neutralized with a basic compound to produce a capsulated pigment.

Specifically, the acid precipitation method may include (1) dispersing a resin and a pigment in an alkaline aqueous medium and if necessary heat-treating them to produce a gel of the resin, (2) neutralizing or acidifying the pH thereby hydrophobizing the resin to fix the resin firmly to the pigment, (3) performing filtration and water washing as necessary to yield a water-containing cake, (4) neutralizing, with a basic compound, a part or the whole of anionic groups of the resin in the water-containing cake and then re-dispersing the resin in an aqueous medium, and (5) performing heat treatment as necessary to produce a gel of the resin.

More specific methods of producing the resin-coated pigment by the phase inversion emulsification method or acid precipitation method include methods described in JP-A Nos. 9-151342 and 10-140065.

For the aqueous ink composition in the invention, the resin-coated pigment in the invention may be obtained using the water-insoluble resin containing a structural unit represented by Formula (I) by a process for preparing a dispersion of a resin-coated pigment by a method including Steps (1) and (2) below. The aqueous ink composition of the invention may be prepared by a method wherein the dispersion of a resin-coated pigment obtained by the preparation process is used with water and an organic solvent to form an aqueous ink.
Step (1): a step of dispersing a mixture containing a water-insoluble resin containing a structural unit represented by Formula (I), an organic solvent, a neutralizing agent, a pigment, and water under stirring or the like to prepare a dispersion.
Step (2): a step of removing the organic solvent from the dispersion.

The stirring method is not particularly limited, and a generally used mixing/stirring apparatus and if necessary a dispersing machine such as an ultrasonic dispersing machine, a high-pressure homogenizer, and a bead mill may be used.

Examples of the organic solvent preferably used herein include alcohol solvents, ketone solvents, and ether solvents. The alcohol solvents include isopropyl alcohol, n-butanol, t-butanol, ethanol, and the like. The ketone solvents include acetone, methyl ethyl ketone, diethyl ketone, methyl isobutyl ketone, and the like. The ether solvents include dibutyl ether, dioxane, and the like. Among these solvents, ketone solvents such as methyl ethyl ketone and alcohol solvents such as isopropyl alcohol are preferable, and methyl ethyl ketone is more preferable.

The neutralizing agent is used for forming a stable emulsified or dispersed state of the specified water-insoluble resin in water by neutralizing some or all of its dissociable groups. The neutralizing agent will be described later in detail.

In Step (2), a dispersion of resin-coated pigment particles wherein the surfaces of the pigment particles are coated with the water-insoluble resin may be obtained from the dispersion obtained in Step (1) by phase inversion into an aqueous system by distilling away the organic solvent in a usual manner such as vacuum distillation. The organic solvent in the resulting dispersion has been substantially removed, and the amount of the organic solvent therein is preferably 0.2% by mass or less, more preferably 0.1% by mass or less.

More preferably, the method comprises, for example, (1) neutralizing the water-insoluble resin having anionic groups, or a solution thereof in an organic solvent, by mixing it with a basic compound (neutralizing agent), (2) mixing the resulting mixture with a pigment to form a suspension, and then dispersing the pigment therein with a dispersing machine or the like to yield a pigment dispersion, and (3) removing the organic solvent for example by distillation, thereby coating the pigment with the specified water-insoluble resin having anionic groups, and dispersing it in an aqueous medium to form an aqueous dispersion.

More specifically, JP-A Nos. 11-209672 and 11-172180 may be referred to.

In the invention, dispersing treatment may be carried out for example with a ball mill, a roll mill, a bead mill, a high-pressure homogenizer, a high-speed stirring/dispersing machine, an ultrasonic homogenizer, or the like.

The content of the pigment coated with the water-insoluble resin in the invention is preferably 1 to 10% by mass, more preferably 2 to 8% by mass, even more preferably 2 to 6% by mass, from the viewpoint of the dispersion stability and density of the aqueous ink composition.

—Organic Solvent—

The aqueous ink composition in the invention contains at least one kind of organic solvent. The organic solvent brings about an effect of drying prevention, moistening, or penetration enhancement. For dying prevention, the organic solvent is used as a drying inhibitor which prevents the ink from being adhered and dried in an ink discharge opening of an ejection nozzle thereby preventing forming an aggregate and clogging in the opening. For drying prevention and moistening, the organic solvent is preferably a water-soluble organic solvent having lower vapor pressure than that of water. For penetration enhancement, the organic solvent may be used as a penetration enhancer for enhancing penetration of ink into paper.

The organic solvent contained in the aqueous ink composition in the invention may be selected appropriately from known organic solvents in consideration of functions such as a drying inhibitor, a humectant or a penetration enhancer, and from the viewpoint of compatibility with water, a water-soluble organic solvent is preferable.

Examples of the water-soluble organic solvent include alkane diols (polyhydric alcohols) such as glycerol, 1,2,6-hexanetriol, trimethylol propane, ethylene glycol, propylene glycol, diethylene glycol, triethylene glycol, tetraethylene glycol, pentaethylene glycol, dipropylene glycol, 2-butene-1,4-diol, 2-ethyl-1,3-hexanediol, 2-methyl-2,4-pentanediol, 1,2-octanediol, 1,2-hexanediol, 1,2-pentanediol, and 4-methyl-1,2-pentanediol; sugars such as glucose, mannose, fructose, ribose, xylose, arabinose, galactose, aldonic acid, glucitol, maltose, cellobiose, lactose, sucrose, trehalose, and maltotriose; sugar alcohols; hyaluronic acid; solid humectants such as urea; C1 to C4 alkyl alcohols such as ethanol, methanol, butanol, propanol, and isopropanol; glycol ethers such as ethylene glycol monomethyl ether, ethylene glycol monoethyl ether, ethylene glycol monobutyl ether, ethylene glycol monomethyl ether acetate, diethylene glycol monomethyl ether, diethylene glycol monoethyl ether, diethylene glycol mono-n-propyl ether, ethylene glycol mono-iso-propyl ether, diethylene glycol mono-iso-propyl ether, ethylene glycol mono-n-butyl ether, ethylene glycol mono-t-butyl ether, diethylene glycol mono-t-butyl ether, 1-methyl-1-methoxybutanol, propylene glycol monomethyl ether, propylene glycol monoethyl ether, propylene glycol mono-t-butyl ether, propylene glycol mono-n-propyl ether, propylene glycol mono-iso-propyl ether, dipropylene glycol monomethyl ether, dipropylene glycol monoethyl ether, dipropylene glycol mono-n-propyl ether, and dipropylene glycol mono-iso-propyl ether; 2-pyrrolidone, N-methyl-2-pyrrolidone, 1,3-dimethyl-2-imidazolidinone, formamide, acetamide, dimethylsulfoxide, sorbitol, sorbitan, acetin, diacetin, triacetin, and sulfolane, and these may be used alone or as a mixture of two or more thereof.

For use as a drying inhibitor or a humectant, polyhydric alcohols are preferable, and examples include glycerol, ethylene glycol, diethylene glycol, triethylene glycol, propylene glycol, dipropylene glycol, tripropylene glycol, 1,3-butanediol, 2,3-butanediol, 1,4-butanediol, 3-methyl-1,3-butanediol, 1,5-pentanediol, tetraethylene glycol, 1,6-hexanediol, 2-methyl-2,4-pentanediol, polyethylene glycol, 1,2,4-butanetriol, 1,2,6-hexanetriol, and the like. These polyhydric alcohols may be used alone or in combination of two or more thereof.

For use as a penetrant, a polyol compound is preferable, and aliphatic diols include, for example, 2-ethyl-2-methyl-1,3-propanediol, 3,3-dimethyl-1,2-butanediol, 2,2-diethyl-1,3-propanediol, 2-methyl-2-propyl-1,3-propanediol, 2,4-dimethyl-2,4-pentanediol, 2,5-dimethyl-2,5-hexanediol, 5-hexene-1,2-diol, 2-ethyl-1,3-hexanediol, and the like. Among them, 2-ethyl-1,3-hexanediol and 2,2,4-trimethyl-1,3-pentanediol may be mentioned as preferable examples.

The organic solvents may be used alone or as a mixture of two or more thereof.

The content of the organic solvent in the aqueous ink composition is preferably 1 to 60% by mass, and more preferably 5 to 40% by mass.

—Water—

The aqueous composition in the invention contains water, and the amount of water is not particularly limited. In particular, the content of water is preferably 10 to 99% by mass, more preferably 30 to 80% by mass, and still more preferably 50 to 70% by mass.

—Neutralizing Agent—

The aqueous ink composition in the invention contains at least one kind neutralizing agent. When the pigment particles coated with the water-insoluble resin are prepared, the neutralizing agent may neutralize acid groups contained in the water-insoluble resin and is used preferably in an amount of 0.5 to 1.5 equivalents, more preferably in the range of 1 to 1.5 equivalents, based on the acid value of the resin.

Examples of the neutralizing agent include, for example, alcoholamines (for example, diethanolamine, triethanolamine, 2-amino-2-ethyl-1,3-propanediol, and the like), alkali metal hydroxides (for example, lithium hydroxide, sodium hydroxide, potassium hydroxide, and the like), ammonium hydroxides (for example, ammonium hydroxide, quaternary ammonium hydroxide, and the like), phosphonium hydroxides, alkali metal carbonates, and the like, among which sodium hydroxide and potassium hydroxide are preferably used.

—Surfactant—

The aqueous ink composition in the invention preferably contains at least one kind of surfactant. The surfactant is used as a surface tension regulator, and examples thereof include nonionic, cationic, anionic and betaine surfactants.

The surfactant is preferably contained in such an amount that the surface tension of the aqueous ink composition may be regulated in the range of 20 to 60 mN/m for good ejection by an inkjet method. Specifically, the content of the surfactant is preferably an amount to enable regulation of surface tension in the range of 20 to 45 mN/m, more preferably an amount to enable regulation of surface tension in the range of 25 to 40 mN/m.

As the surfactant, a compound having a structure having hydrophilic and hydrophobic moieties in the molecule may be effectively used, and any of anionic, cationic, amphoteric and nonionic surfactants may be used.

Specific examples of the anionic surfactant include sodium dodecylbenzenesulfonate, sodium laurylsulfate, sodium alkyldiphenyl ether disulfonate, sodium alkylnaphthalenesulfonate, sodium dialkylsulfosuccinate, sodium stearate, potassium oleate, sodium dioctylsulfosuccinate, sodium polyoxyethylenealkyl ether sulfate, sodium polyoxyethylenealkyl ether sulfate, sodium polyoxyethylenealkylphenyl ether sulfate, sodium dialkylsulfosuccinate, sodium stearate, sodium oleate, sodium tert-octylphenoxyethoxypolyethoxyethylsulfate, and the like, one or two or more of which may be selected for use.

Specific examples of the nonionic surfactant include polyoxyethylene lauryl ether, polyoxyethylene octyl phenyl ether, polyoxyethylene oleyl phenyl ether, polyoxyethylene nonyl phenyl ether, oxyethylene/oxypropylene block copolymers, tert-octylphenoxyethylpolyethoxyethanol, nonylphenoxyethylpolyethoxyethanol, and the like, one or two or more of which may be selected for use.

Specific examples of the cationic surfactant include tetraalkyl ammonium salts, alkylamine salts, benzalkonium salts, alkyl pyridium salts, imidazolium salts, and the like, and specific examples include, for example, dihydroxyethyl stearylamine, 2-heptadecenyl-hydroxyethyl imidazoline, lauryl dimethyl benzyl ammonium chloride, cetyl pyridinium chloride, stearamidomethylpyridium chloride, and the like.

The content of the surfactant in the aqueous ink composition is not particularly limited and is preferably 1% by mass or more, more preferably 1 to 10% by mass, and still more preferably 1 to 3% by mass.

—Others—

The aqueous ink composition in the invention may, besides the components described above, contain other components if necessary, for example resin fine particles or polymer latexes, an ultraviolet absorber, a fading inhibitor, a fungicide, a rust preventive, an antioxidant, an emulsion stabilizer, a preservative, an antifoaming agent, a viscosity regulator, a dispersion stabilizer, a chelating agent, and the like.

The resin fine particles that may be used include, for example, fine particles such as an acrylic resin, a vinyl acetate resin, a styrene-butadiene resin, a vinyl chloride resin, an acryl-styrene resin, a butadiene resin, a styrene resin, a crosslinked acrylic resin, a crosslinked styrene resin, a benzoguanamine resin, a phenol resin, a silicone resin, an epoxy resin, an urethane resin, a paraffin resin, and fluorine resin, or polymer latexes containing them.

Preferable examples include an acrylic resin, an acryl-styrene resin, a styrene resin, a crosslinked acrylic resin and a crosslinked styrene resin.

The weight-average molecular weight of the resin fine particles is preferably 10,000 or more but 200,000 or less, and more preferably 100,000 or more but 200,000 or less.

The average particle diameter of the resin fine particles is preferably in the range of 10 nm to 1 μm, more preferably in the range of 10 to 200 nm, still more preferably in the range of 20 to 100 nm, and further more preferably in the range of 20 to 50 nm.

The amount of the resin fine particles added is preferably 0.5 to 20% by mass, more preferably 3 to 20% by mass, and still more preferably 5 to 15% by mass, based on the aqueous ink composition.

The glass transition temperature (Tg) of the resin fine particles is preferably 30° C. or more, more preferably 40° C. or more, and still more preferably 50° C. or more.

The particle diameter distribution of the polymer particles is not particularly limited and may be broad particle diameter distribution or monodisperse particle diameter distribution. Polymer fine particles having monodisperse particle diameter distribution may be used as a mixture of two or more thereof.

Examples of the ultraviolet absorber include, for example, a benzophenone ultraviolet absorber, a benzotriazole ultraviolet absorber, a salicylate ultraviolet absorber, a cyanoacrylate ultraviolet absorber, a nickel complex salt ultraviolet absorber, and the like.

As the fading inhibitor, various organic or metal complex fading inhibitors may be used. The organic fading inhibitors include hydroquinones, alkoxyphenols, dialkoxyphenols, phenols, anilines, amines, indanes, chromanes, alkoxyanilines, heterocycles, and the like, and the metal complexes include nickel complexes, zinc complexes, and the like.

Examples of the fungicide include sodium dehydroacetate, sodium benzoate, sodium pyridine thion-1-oxide, ethyl p-hydroxybenzoate, 1,2-benzisothiazolin-3-one, sodium sorbate, sodium pentachlorophenol, and the like. These fungicides are used preferably in an amount of 0.02 to 1.00% by mass in ink.

Examples of the rust preventive include, for example, acidic sulfites, sodium thiosulfate, ammonium thiodiglycolate, diisopropyl ammonium nitrite, pentaerythritol tetranitrate, dicylohexyl ammonium nitrite, and the like.

Examples of the antioxidant include, for example, phenol antioxidants (including hindered phenol antioxidants), amine antioxidants, sulfur-based antioxidants, phosphorus-based antioxidants, and the like.

Examples of the chelating agent includes, for example, sodium ethylenediaminetetraacetate, sodium nitrilotriacetate, sodium hydroxyethylethylenediaminetriacetate, sodium diethylenetriaminepentaacetate, sodium uramyldiacetate, and the like.

—Physical Properties of the Ink Composition—

The surface tension of the aqueous ink composition (25° C.) in the invention is preferably 20 mN/m or more but 60 mN/m or less. The surface tension is more preferably 20 mN/m or more but 45 mN/m or less, and still more preferably 25 mN/m or more but 40 mN/m or less.

The surface tension is determined by measuring the aqueous ink under the condition of 25° C. with an Automatic Surface Tensiometer CBVP-Z (trade name, manufactured by Kyowa Interface Science Co., Ltd.).

The viscosity at 20° C. of the aqueous ink composition in the invention is preferably 1.2 mPa·s or more but 15.0 mPa·s or less, more preferably 2 mPa·s or more but less than 13 mPa·s, and still more preferably 2.5 mPa·s or more but less than 10 mPa·s.

The viscosity is determined by measuring the aqueous ink under the condition of 20° C. with a Viscometer TV-22 (trade name, manufactured by Toki Sangyo Co., Ltd.).

The aqueous ink composition in the invention may be used in formation of a multicolor image (for example, a full color image). For formation of a full color image, a magenta color ink composition, a cyan color ink composition and a yellow color ink composition may be used, and for further regulating color tone, a block color ink composition may also be used.

Red (R), green (G), blue (B) and white (W) color ink compositions other than the colors of yellow (Y), magenta (M) and cyan (C), and particular color ink compositions in the field of printing, may also be used.

The ink compositions of each color tone may be prepared by changing the hue of the pigment used as a colorant as desired.

—Recording Mode—

The ink set of the invention may be used in a recording mode (first recording mode) of recording a color image by ejecting the cyan color aqueous ink composition, the magenta color aqueous ink composition, the yellow color aqueous ink composition, and if necessary the black color aqueous ink composition onto a recording medium by an inkjet method according to the information of an image to be recorded.

The ink set of the invention may be used not only in the first recording mode but also in a recording mode (second recording mode) of recording an image by using the cyan color aqueous ink composition, the magenta color aqueous ink composition, the yellow color aqueous ink composition, and if necessary the black color aqueous ink composition, together with an aqueous liquid composition (aggregating liquid) containing a component which when mixed with each of the aqueous ink compositions, aggregates the pigment or the like in the aqueous ink composition, and by contacting the aqueous ink compositions with the aqueous liquid composition.

—Aqueous Liquid Composition—

Hereinafter, the aqueous liquid composition used in the second recording mode is described.

The aqueous liquid composition contains at least an aggregating component which when mixed with the aqueous ink composition mentioned above, aggregates particles of the pigment or the like in the aqueous ink composition, and may further contain other components as necessary.

—Aggregating Component—

The aqueous liquid composition contains at least one kind of aggregating component which aggregates particles of the pigment or the like in the aqueous ink composition. The aqueous ink composition ejected by the inkjet method is mixed with the aqueous liquid composition, thereby promoting aggregation of particles of the pigment or the like dispersed stably in the aqueous ink composition.

Examples of the aqueous liquid composition include liquid compositions capable of forming an aggregate by changing the pH of the aqueous ink composition. The pH (25° C.) of the aqueous liquid composition is preferably 6 or less, more preferably 4 or less. In particular, the pH (25° C.) is preferably in the range of 1 to 4, more preferably 1 to 3. In this case, the pH (25° C.) of the aqueous ink composition is preferably 7.5 or more (more preferably 8 or more).

From the viewpoint of image density, resolution, and speeding up of inkjet recording, it is preferable in the invention that the pH (25° C.) of the aqueous ink composition is 7.5 or more, and the pH (25° C.) of the aqueous liquid composition is 4 or less.

Examples of the aggregating component which aggregates the pigment include multivalent metal salts, organic acids, polyallylamines, derivatives thereof, and the like.

The multivalent metal salts include salts of alkaline earth metals (for example, magnesium, calcium) in the group II in the periodic table, transition metals (for example, lanthanum) in the group III in the periodic table, cations (for example, aluminum) in the group XIII in the periodic table, and lanthanides (for example, neodymium). Salts of these metals are preferably carboxylates (formates, acetates, benzoates, and the like), nitrates, chlorides, and thiocyanates. Particularly preferable are calcium or magnesium carboxylates (formate, acetate, benzoate, and the like), calcium or magnesium nitrate, calcium chloride, magnesium chloride, and calcium or magnesium thiocyanate.

The organic acid may be preferably selected from, for example, polyacrylic acid, acetic acid, glycolic acid, malonic acid, malic acid, maleic acid, ascorbic acid, succinic acid, glutaric acid, fumaric acid, citric acid, tartaric acid, lactic acid, sulfonic acid, orthophosphoric acid, pyrrolidonecarboxylic acid, pyronecarboxylic acid, pyrrolecarboxylic acid, furancarboxylic acid, pyridinecarboxylic acid, coumaric acid, thiophenecarboxylic acid, nicotinic acid, derivatives of these compounds or salts thereof.

The aggregating components may be used alone or as a mixture of two or more thereof.

The content, in the aqueous liquid composition, of the aggregating component for aggregating the pigment is preferably in the range of 1 to 20% by mass, more preferably 5 to 20% by mass, and even more preferably 10 to 20% by mass.

—Image Recording Method—

The ink set of the invention may be used in either the first or second recording mode described above.

In the first recording mode, an image is recorded by applying the cyan color aqueous ink composition, the magenta color aqueous ink composition, the yellow color aqueous ink composition, and if necessary the black color aqueous ink composition and aqueous ink compositions of other hues, onto a recording medium by the inkjet method.

In the second recording mode, an image is formed by applying the cyan color aqueous ink composition, the magenta color aqueous ink composition, the yellow color aqueous ink composition, and if necessary the black color aqueous ink composition and aqueous ink compositions of other hues, onto a recording medium by the inkjet method, and applying an aqueous liquid composition containing a component which aggregates the pigment in the aqueous ink composition, onto the recording medium, thereby contacting the aqueous liquid composition with the aqueous ink compositions.

In either the first or second recording mode, at least cyan color, magenta color and yellow color (as well as preferably black color) aqueous ink compositions are each composed of an aqueous ink composition containing, as a colorant, a pigment coated with the water-insoluble resin in the invention containing the structural unit of Formula (I) above, whereby recorded color images have improved scratch resistance, the adhesion or accumulation, onto liquid discharging portions, of the aggregate generated by contacting the two liquids with each other may be reduced, and removal of the adhered aggregate is facilitated, thus preventing a failure in ejection directionality during ejection of ink as well as image defects such as white spots, to produce high-resolution images. The frequency of maintenance of a discharge apparatus may be reduced, and maintainability may also be improved.

In the ink application step, the aqueous ink composition is applied by the inkjet method. Specifically, an energy is applied to the aqueous ink composition, and the aqueous ink composition is thereby ejected onto a recording medium to form a colored image, for example, onto plain paper, resin coated paper, inkjet special paper described, for example, in JP-A Nos. 8-169172, 8-27693, 2-276670, 7-276789, 9-323475, 62-238783, 10-153989, 10-217473, 10-235995, 10-337947, 10-217597 and 10-337947, film, electrophotographic common paper, cloth, glass, metal, ceramic or the like. As a preferable inkjet recording method in the invention, a method described in paragraphs [0093] to [0105] in JP-A No. 2003-306623 is applicable.

In the invention, the inkjet recording method is not limited. The invention may be applied to any known inkjet recording method such as an charge control method which utilizes electrostatic attraction to eject ink, a drop-on-demand method (pressure pulse method) utilizing vibrational pressure of piezoelectric element, an acoustic inkjet method which comprises converting electrical signal to acoustic beam with which the ink is irradiated to produce a radiation pressure that is utilized to eject the ink, and a thermal inkjet (bubble jet™) method which comprises heating the ink to form bubbles that raise the pressure to eject the ink. As the inkjet method, it is possible to effectively utilize an inkjet method of ejecting an ink through a nozzle by the acting force due to a state change of an ink upon rapid volume change by an action of heat energy according to a method specifically described in JP-A No. 54-59936.

Examples of the inkjet-recording method include a method of ejecting a lot of small volume droplets of a so-called photo ink having a low concentration, a system of using multiple inks that have substantially the same hue and a different concentration for improving image quality, and a method of using a transparent and colorless ink.

The inkjet head used in the inkjet method may be in an on-demand system or a continuous system. Specific examples of the discharge method include an electromechanical transduction method (for example, single-cavity type, double-cavity type, vender type, piston type, shear mode type, shared wall type, and the like), an electrothermal transduction method (for example, thermal inkjet type, bubble jet™ type, and the like), an electrostatic suction method (for example, electric-field control type, slit jet type, and the like), and an electric discharge method (for example, spark jet type, and the like), any of which may be used in the invention.

The ink nozzle used in recording with the inkjet method is not particularly limited and may be appropriately selected depending on the object.

In the aggregating component application step in the second recording mode, the aqueous liquid composition is applied onto a recording medium before or after being coated with the aqueous ink compositions. The aqueous liquid composition may be applied by known methods such as a coating method, inkjet method and dipping method. The coating method may be carried out in a known manner using a bar coater, extrusion die coater, air doctor coater, blade coater, rod coater, knife coater, squeeze coater, reverse roll coater, bar coater, and the like. The inkjet method has been described in detail above.

In the second recording mode, it is preferable that after application of the aqueous liquid composition, the aqueous ink composition is applied. That is, it is preferable that before the aqueous ink compositions are applied onto a recording medium, the aqueous liquid composition for aggregating particles of the pigment or the like in the aqueous ink compositions is applied, and the aqueous ink compositions are then applied so as to contact with the aqueous liquid composition applied previously onto the recording medium, thereby forming an image. High-speed inkjet recording may thereby be achieved, and an image of high density and resolution may be obtained even by high-speed recording.

A polymer latex compound may be additionally used to provide surface gloss or water resistance or to improve weatherability when an image is formed. The time of applying the latex compound may be before or after application of the ink compositions or simultaneous with application of the ink compositions. Therefore, the latex compound may be used by applying it onto a recording medium or by adding it to the aqueous ink compositions, or the polymer latex compound may be prepared as another liquid and used alone.

Specifically, those methods disclosed in JP-A Nos. 2002-166638 (Japanese Patent Application No. 2000-363090), 2002-121440 (Japanese Patent Application No. 2000-315231), 2002-154201 (Japanese Patent Application No. 2000-354380), 2002-144696 (Japanese Patent Application No. 2000-343944), and 2002-80759 (Japanese Patent Application No. 2000-268952) may be preferably used.

In recording of images, another step may further be arranged in addition to the ink application step and the aggregating component application step. Another step is not particularly limited and may be selected, for example, from a drying and removing step of removing, by drying, an organic solvent in the aqueous ink composition applied onto a recording medium, a thermally fixing step of thermally melt-fixing resin fine particles or polymer latex contained in the aqueous ink composition, depending on the object.

Another example of the image recording method includes a method using an intermediate transfer material as a recording medium on which an image is to be first formed, which comprises recording an image on the intermediate transfer material, and then transferring the image on the intermediate transfer material onto a desired recording medium.

For example, the second recording mode may be a method using an intermediate transfer material as a recording medium on which an image is to be first formed, which comprises an ink application step of applying at least cyan color, magenta color and yellow color (as well as preferably black color) aqueous ink compositions in the ink set of the invention onto the intermediate transfer material by the inkjet method, an aggregation component application step of applying an aqueous liquid composition containing a component for aggregating the pigment in the aqueous ink composition, onto the intermediate transfer material, thereby contacting the aqueous ink composition and the aqueous liquid composition with each other to form an image on the intermediate transfer material, and a transfer step of transferring the image formed on the intermediate transfer material onto a desired, final recording medium.

In this case, other steps such as the drying and removing step and the thermally fixing step may further be arranged in the same manner as described above, and in a preferable mode, the ink application step is preferably carried out after applying the aqueous liquid composition in the aggregating component application step.

According to the invention, the following exemplary embodiments <1>-<7> are provided.
<1> An ink set for inkjet recording comprising:

a cyan color aqueous ink composition containing a cyan color pigment, an organic solvent, a neutralizing agent and water,

a magenta color aqueous ink composition containing a magenta color pigment, an organic solvent, a neutralizing agent and water, and

a yellow color aqueous ink composition containing a yellow color pigment, an organic solvent, a neutralizing agent and water,

wherein the cyan color pigment, the magenta color pigment, and the yellow color pigment are each a pigment coated with a water-insoluble resin containing a structural unit represented by the following Formula (I):

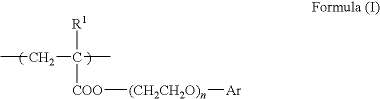

wherein R¹ represents a hydrogen atom or a methyl group, Ar represents an unsubstituted or substituted aromatic ring, and n represents an average repeating number and is from 1 to 6.
<2> The ink set for inkjet recording of <1>, wherein the aromatic ring represented by Ar in Formula (I) is an unsubstituted or substituted benzene ring.
<3> The ink set for inkjet recording of <1>, further comprising a black color aqueous ink composition containing a carbon black, an organic solvent, a neutralizing agent and water, wherein the carbon black is a pigment coated with a water-insoluble resin containing a structural unit represented by Formula (I).
<4> The ink set for inkjet recording of <1>, wherein

the water-insoluble resin comprises a hydrophilic structural unit (A) and a hydrophobic structural unit (B),

the content of aromatic rings in the water-insoluble resin is 20% by mass or less based on the total mass of the water-insoluble resin,

the hydrophobic structural unit (B) includes the structural unit represented by Formula (I),

the content of the hydrophilic structural unit (A) in the water-insoluble resin is 15% by mass or less based on the total mass of the water-insoluble resin, and

the hydrophilic structural unit (A) includes a structural unit derived from (meth)acrylic acid.
<5> The ink set for inkjet recording of <1>, wherein the water-insoluble resin has an acid value of 30 mg KOH/g or more but 100 mg KOH/g or less.
<6> The ink set for inkjet recording of <1>, wherein the pigment coated with a water-insoluble resin containing a structural unit represented by Formula (I) is a pigment coated with the water-insoluble resin by a phase inversion emulsification method.
<7> The ink set for inkjet recording of <1>, wherein at least one of the aqueous ink compositions further comprises a surfactant.

Therefore, according to the invention, there may be provided an ink set for inkjet recording capable of recording images excellent in scratch resistance and preventing image defects such as white spots.

### EXAMPLES

Hereinafter, the invention is described in more detail with reference to the Examples, but within the gist of the invention, the invention is not limited to the Examples. Unless otherwise specified, “parts” is on a mass basis.

The weight-average molecular weight was determined by gel permeation chromatography (GPC). In GPC, three columns of TSKgel SUPER MULTIPORE HZ-H (trade name, manufactured by Tosoh Corporation, 4.6 mmID×15 cm) were used in a GPC apparatus (trade name: HLC-8020 GPC, manufactured by Tosoh Corporation) with THF (tetrahydrofuran) as eluent. The GPC conditions are as follows: the sample concentration, 0.35% by mass; the flow rate, 0.35 ml/min; the sample injection volume, 10 μl; the measurement temperature, 40° C.; and detection, IR detector. A calibration curve was prepared from 8 samples of “Standard Sample TSK standard, polystyrene” manufactured by Tosoh Corporation: “F-40”, “F-20”, “F-4”, “F-1”, “A-5000”, “A-2500”, “A-1000”, and “n-propyl benzene”.

### Synthesis Example 1

—Synthesis of Resin Dispersant P-1—

Methyl ethyl ketone, 88 g, was introduced into a 1000-ml three-neck flack equipped with a stirrer and a condenser, and then heated to 72° C. in a nitrogen atmosphere, and a solution prepared by dissolving 0.85 g of dimethyl-2,2′-azobisisobutyrate, 70 g of phenoxyethyl methacrylate, 10 g of methacrylic acid and 20 g of methyl methacrylate in 50 g of methyl ethyl ketone was added dropwise thereto over 3 hours. After the completion of dropwise addition, the mixture was further reacted for 1 hour, and then a solution prepared by dissolving 0.42 g of dimethyl-2,2′-azobisisobutyrate in 2 g of methyl ethyl ketone was added to the reaction mixture which was then heated to 78° C. and heated for 4 hours. The resulting reaction solution was re-precipitated twice in an excess of hexane, and the precipitated resin was dried to give 96.5 g of a phenoxyethyl methacrylate/methyl methacrylate/methacrylic acid (copolymerization ratio (molar ratio)=70/20/10) copolymer (Resin Dispersant P-1).

The composition of the resulting resin dispersant P-1 was confirmed by ¹H-NMR, and the weight-average molecular weight (Mw) determined by GPC was 49400. The acid value of this polymer as determined by a method described in JIS Standards (JIS K 0070, 1992) was 65.2 mg KOH/g.

—Synthesis of Resin Dispersants P-2 to P-4—

Resin Dispersants P-2 to P-4 were synthesized in almost the same manner as in synthesizing Resin Dispersant P-1 except that 70 g of phenoxyethyl methacrylate, 10 g of methacrylic acid and 20 g of methyl methacrylate in synthesis of Resin Dispersant P-1 were changed to those (monomer types and ratio) shown in Table 1 below.

### Example 1

—Preparation of Dispersion C1 of Resin-Coated Pigment Particles—

10 parts of Pigment Blue 15:3 (trade name: PHTHALOCYANINE BLUE A220, manufactured by Dainichiseika Colour & Chemicals Mfg. Co., Ltd.), 4.5 parts of the phenoxyethyl methacrylate/methyl methacrylate/methacrylic acid copolymer (Resin Dispersant P-1), 45.5 parts of methyl ethyl ketone, 5.3 parts of 1 N aqueous NaOH, and 84.7 parts of ion-exchanged water were mixed, and dispersed with a bead mill using 0.1 mmφ zirconia beads for 2 to 6 hours. From the resulting dispersion, the methyl ethyl ketone was removed at 55° C. under reduced pressure and a part of the water was removed, whereby Dispersion C1 (cyan color) of resin-coated pigment particles containing 10.2% by mass pigment was prepared.

—Preparation of Dispersion M1 of Resin-Coated Pigment Particles—

10 parts of magenta pigment (trade name: CROMOPHTAL JET MAGENTA DMQ, manufactured by Ciba Specialty Chemicals), 4.5 parts of the phenoxyethyl methacrylate/methyl methacrylate/methacrylic acid copolymer (Resin Dispersant P-1), 21.5 parts of methyl ethyl ketone, 5.3 parts of 1 N aqueous NaOH, and 78.7 parts of ion-exchanged water were mixed, and dispersed with a bead mill using 0.1 mmφ zirconia beads for 2 to 6 hours. From the resulting dispersion, the methyl ethyl ketone was removed at 55° C. under reduced pressure and a part of the water was removed, whereby Dispersion M1 (magenta color) of resin-coated pigment particles containing 12% by mass pigment was prepared.

—Preparation of Dispersion Y1 of Resin-Coated Pigment Particles—

10 parts of yellow pigment (trade name: IRGALITE YELLOW GS, manufactured by Ciba Specialty Chemicals), 4.5 parts of the phenoxyethyl methacrylate/methyl methacrylate/methacrylic acid copolymer (Resin Dispersant P-1), 15.5 parts of methyl ethyl ketone, 5.3 parts of 1 N aqueous NaOH, and 84.7 parts of ion-exchanged water were mixed, and dispersed with a bead mill using 0.1 mmφ zirconia beads for 2 to 6 hours. From the resulting dispersion, the methyl ethyl ketone was removed at 55° C. under reduced pressure and a part of the water was removed, whereby Dispersion Y1 (yellow color) of resin-coated pigment particles containing 12% by mass pigment was prepared.

—Measurement of the Particle Diameter of the Resin-Coated Pigment Particles—

Each of the resulting resin-coated pigment particle dispersions was measured for its volume-average particle diameter by a dynamic light scattering method using a Nanotrac particle diameter distribution measuring instrument (trade name: UPA-EX 150, manufactured by NIKKISO Co., Ltd.). In this measurement, 10 ml ion-exchanged water was added to 30 μl of the resin-coated pigment particle dispersion to prepare a measurement sample liquid which was then measured at a controlled temperature of 25° C. The measurement results are shown in Table 1.

—Preparation of Aqueous Inks C1, M1 and Y1—

Then, the resulting dispersions of resin-coated pigment particles were used to prepare Aqueous Inks C1, M1 and Y1 with the following compositions. Any of these aqueous inks had pH 9.0 at 25° C.

<Composition of Aqueous Ink C1>

| | | |
|---|---|---|
| The resin-coated pigment particle C1 dispersion | 37.2 | parts |
| Water-soluble solvent (trade name: SUNNIX GP250, | 10 | parts |
| manufactured by Sanyo Chemical Industries, Ltd.) | | |
| Diethylene glycol monoethyl ether | 5 | parts |
| Olefin (trade name: E1010, manufactured by Nisshin | 1 | part |
| Chemicals Co., Ltd.) | | |
| Ion-exchanged water | 46.8 | parts |

<Composition of Aqueous Ink M1>

| | | |
|---|---|---|
| The resin-coated pigment particle M1 dispersion | 31.7 | parts |
| Water-soluble solvent (trade name: SUNNIX GP250, | 10 | parts |
| manufactured by Sanyo Chemical Industries, Ltd.) | | |
| Diethylene glycol monoethyl ether | 5 | parts |
| Olefin (trade name: E1010, manufactured by Nisshin | 1 | part |
| Chemicals Co., Ltd.) | | |
| Ion-exchanged water | 52.3 | parts |

<Composition of Aqueous Ink Y1>

| | | |
|---|---|---|
| The resin-coated pigment particle Y1 dispersion | 31.7 | parts |
| Water-soluble solvent (trade name: SUNNIX GP250, | 10 | parts |
| manufactured by Sanyo Chemical Industries, Ltd.) | | |
| Diethylene glycol monoethyl ether | 5 | parts |
| Olefin (trade name: E1010, manufactured by Nisshin | 1 | part |
| Chemicals Co., Ltd.) | | |
| Ion-exchanged water | 52.3 | parts |

In the manner described above, an ink set consisting of three colors (cyan color, magenta color and yellow color) Aqueous Inks C1, M1 and Y1 was prepared.

—Evaluation—

As an inkjet recording apparatus, an inkjet recording apparatus equipped with an experimental print head with 600 dpi and 256 nozzles was prepared, charged with the ink set obtained as described above, and used in evaluation by the following method. As a recording medium, paper (trade name: FX-L, manufactured by Fuji Xerox Co., Ltd.) was used. The measurement and evaluation results are shown in Table 1 below.

(Scratch Resistance)

A 100% coverage pattern was recorded on FX-L paper, and another unused FX-L paper (blank paper) was placed thereon and pressed against the pattern under a loading of 4.9×10⁴ N/m² while being reciprocated 5 times, and the degree of scratch on the coverage pattern was evaluated visually under the following criteria with a previously prepared boundary sample.

### <Evaluation Criteria>

AA: Scratch was not generated.
A: Slight scratch was generated.
B: Scratch was generated but at a practically acceptable level.
C: Scratch was remarkable at a practically unacceptable level.

(White Dots)

The obtained aqueous inks were ejected via separate heads onto FX-L paper for 30 minutes. As a maintenance operation, pressurization was carried out at a pressure of 15 KPa for 10 seconds, and then wiping was carried out with a clean wiper FF-390C (trade name, manufactured by Kuraray Co., Ltd.), and thereafter the aqueous inks were further ejected for 5 minutes, and after 5 minutes, the image (5 cm×5 cm) recorded on the FX-L paper was observed. Then, the observed image was evaluated visually under the following evaluation criteria.

### <Evaluation Criteria>

A: No white dot was generated.
B: Two or less white dots were generated.
C: Three to ten white dots were generated.
D: More than ten white dots were generated.

### Examples 2 to 4

Dispersions of resin-coated pigment particles were obtained, the particle diameter was measured, and aqueous inks were prepared and evaluated in the same manner as in Example 1 except that the phenoxyethyl methacrylate/methyl methacrylate/methacrylic acid copolymer (Resin Dispersant P-1) used in preparing Dispersions C1, M1 and Y1 of resin-coated pigment particles in Example 1 was changed to Resin Dispersants P-2, P-3 and P-4 respectively as shown in Table 1. When cyan, magenta and yellow Dispersions C1, M1 and Y1 were prepared using Resin Dispersant P-2, the amount of 1 N aqueous NaOH was 5.8 parts, and the amount of ion-exchanged water was reduced by 0.5 parts. When cyan, magenta and yellow Dispersions C1, M1 and Y1 were prepared using Resin Dispersant P-3, the amount of 1 N aqueous NaOH was 6.3 parts, and the amount of ion-exchanged water was reduced by 1 part. When cyan, magenta and yellow Dispersions C1, M1 and Y1 were prepared using Resin Dispersant P-4, the amount of 1 N aqueous NaOH was 6.3 parts, and the amount of ion-exchanged water was reduced by 1.0 part. The measurement and evaluation results are shown in Table 1 below.

### Comparative Examples 1 to 3

Dispersions of resin-coated pigment particles were obtained, the particle diameter was measured, and aqueous inks were prepared and evaluated in the same manner as in Example 1 except that the phenoxyethyl methacrylate/methyl methacrylate/methacrylic acid copolymer (Resin Dispersant P-1) used in preparing Dispersions C1, M1 and Y1 of resin-coated pigment particles in Example 1 was changed to a benzyl methacrylate/methacrylic acid (=90/10 [% by mass]) copolymer (Comparative Example 1), a benzyl methacrylate/methacrylic acid (=80/20 [% by mass]) copolymer (Comparative Example 2), and a styrene/methacrylic acid (=90/10 [% by mass]) copolymer (Comparative Example 3), respectively as shown in Table 1. The measurement and evaluation results are shown in Table 1 below. In preparation of the dispersion with a benzyl methacrylate/methacrylic acid (=80/20 [% by mass]) copolymer (Comparative Example 2), the amount of 1 N aqueous NaOH was 10.5 parts, and accordingly the amount of ion-exchanged water was reduced by 5.2 parts.

### Example 5

In the manner described below, an ink set consisting of four colors (cyan color, magenta color, yellow color and black color) Aqueous Inks C1, M1, Y1 and Bk1 was prepared, and the ink set was evaluated in the same manner as in Example 1. The measurement and evaluation results are shown in Table 1 below.

—Preparation of Aqueous Inks—
(1) First, the same aqueous inks C1, M1 and Y1 as in Example 1 were prepared.
(2) Then, components in the following composition were mixed to prepare Aqueous Ink Bk1. The pH of Aqueous Ink Bk1 at 25° C. was 9.0.

<Composition of Aqueous Ink Bk1>

| | | |
|---|---|---|
| The resin-coated pigment particle Bk1 dispersion as shown | 32.5 | parts |
| below | | |
| Water-soluble solvent (trade name: SUNNIX GP250, | 10 | parts |
| manufactured by Sanyo Chemical Industries, Ltd.) | | |
| Diethylene glycol monoethyl ether | 5 | parts |
| Olefin E1010 (trade name, manufactured by Nisshin | 1 | part |
| Chemicals Co., Ltd.) | | |
| Ion-exchanged water | 51.5 | parts |

—Preparation of Dispersion Bk1 of Resin-Coated Pigment Particles—

10 parts of carbon black pigment (trade name: NIPEX180-IQ, manufactured by Evonik Degussa), 4.5 parts of the phenoxyethyl methacrylate/methyl methacrylate/methacrylic acid copolymer (Resin Dispersant P-1), 27.5 parts of methyl ethyl ketone, 5.8 parts of 1 N aqueous NaOH, and 72.2 parts of ion-exchanged water were mixed, and dispersed with a bead mill using 0.1 mmφ zirconia beads for 2 to 6 hours. From the resulting dispersion, the methyl ethyl ketone was removed at 55° C. under reduced pressure and a part of the water was removed, whereby Dispersion Bk1 (black color) of resin-coated pigment particles containing 12% by mass pigment was prepared.

### Example 6 to 8

Dispersions of resin-coated pigment particles were obtained, the particle diameter was measured, and aqueous inks were prepared and evaluated in the same manner as in Example 5 except that the phenoxyethyl methacrylate/methyl methacrylate/methacrylic acid copolymer (Resin Dispersant P-1) used in preparing Dispersions C1, M1, Y1 and Bk1 of resin-coated pigment particles in Example 5 was changed to Resin Dispersants P-2, P-3 and P-4 respectively as shown in Table 1. When cyan, magenta and yellow Dispersions C1, M1 and Y1 were prepared using Resin Dispersant P-2, the amount of 1 N aqueous NaOH was 5.8 parts, and the amount of ion-exchanged water was reduced by 0.5 part, and when black Dispersion Bk1 was prepared using Resin Dispersant P-2, the amount of 1 N aqueous NaOH was 6.3 parts, and the amount of ion-exchanged water was reduced by 0.5 part. When cyan, magenta and yellow Dispersions C1, M1 and Y1 were prepared using Resin Dispersant P-3, the amount of 1 N aqueous NaOH was 6.3 parts, and the amount of ion-exchanged water was reduced by 1.0 part, and when black Dispersion Bk1 was prepared using Resin Dispersant P-3, the amount of 1 N aqueous NaOH was 6.8 parts, and the amount of ion-exchanged water was reduced by 1.0 part. When cyan, magenta and yellow Dispersions C1, M1 and Y1 were prepared using Resin Dispersant P-4, the amount of 1 N aqueous NaOH was 6.3 parts, and the amount of ion-exchanged water was reduced by 1.0 part, and when black Dispersion Bk1 was prepared using Resin Dispersant P-4, the amount of 1 N aqueous NaOH was 6.8 parts, and the amount of ion-exchanged water was reduced by 1.0 part. The measurement and evaluation results are shown in Table 1 below.

### Comparative Examples 4 to 6

Dispersions of resin-coated pigment particles were obtained, the particle diameter was measured, and aqueous inks were prepared and evaluated in the same manner as in Example 5 except that the phenoxyethyl methacrylate/methyl methacrylate/methacrylic acid copolymer (Resin Dispersant P-1) used in preparing Dispersions C1, M1, Y1 and Bk1 of resin-coated pigment particles in Example 5 was changed to a benzyl methacrylate/methacrylic acid (=90/10 [% by mass]) copolymer (Comparative Example 4), a benzyl methacrylate/methacrylic acid (=80/20 [% by mass]) copolymer (Comparative Example 5) and a styrene/methacrylic acid (=90/10 [% by mass]) copolymer (Comparative Example 6), respectively as shown in Table 1. When cyan, magenta and yellow Dispersions C1, M1 and Y1 were prepared by using the benzyl methacrylate/methacrylic acid (=80/20 [% by mass]) copolymer (Comparative Example 5), the amount of 1 N aqueous NaOH was 10.5 parts, and the amount of ion-exchanged water was reduced by 5.2 parts, and when black Dispersion Bk1 was prepared using the above copolymer, the amount of 1 N aqueous NaOH was 11 parts, and the amount of ion-exchanged water was reduced by 5.2 parts. The measurement and evaluation results are shown in Table 1 below.

### Comparative Example 7

A dispersion of resin-coated pigment particles was obtained, the particle diameter was measured, and aqueous inks were prepared and evaluated in the same manner as in Example 5 except that the phenoxyethyl methacrylate/methyl methacrylate/methacrylic acid copolymer (Resin Dispersant P-1) used in “preparing Dispersion C1 (cyan color) of resin-coated pigment particles” in Example 5 was changed to a styrene/methacrylic acid (=90/10 [% by mass]) copolymer. The measurement and evaluation results are shown in Table 1 below.

### Comparative Example 8

A dispersion of resin-coated pigment particles was obtained, the particle diameter was measured, and aqueous inks were prepared and evaluated in the same manner as in Example 5 except that the phenoxyethyl methacrylate/methyl methacrylate/methacrylic acid copolymer (Resin Dispersant P-1) used in “preparing Dispersion C1 (cyan color) of resin-coated pigment particles” in Example 5 was changed to a styrene/methacrylic acid (=90/10 [% by mass]) copolymer, and the phenoxyethyl methacrylate/methyl methacrylate/methacrylic acid copolymer (Resin Dispersant P-1) used in “preparing Dispersion Y1 (yellow color) of resin-coated pigment particles” in Example 5 was changed to a benzyl methacrylate/methacrylic acid (=90/10 [% by mass]) copolymer. The measurement and evaluation results are shown in Table 1 below.

TABLE 1

| | | | | | | Dispersion | | |
|---|---|---|---|---|---|---|---|---|
| | | Water-Insoluble Resin | | | | Particle | | Evaluation |
| | | | | Weight-Average | Acid Value | Diameter | Scratch | of White |
| | Constitution of Ink Set | | Type (% by mass) | Molecular Weight | [mgKOH/g] | [nm] | Resistance | spots |
| Example 1 | Cyan/magenta/yellow | P-1 | Phenoxyethyl methacrylate/ | 49400 | 65.2 | 95/100/125 | A | B |
| | | | methyl methacrylate/ | | | | | |
| | | | methacrylic acid copolymer | | | | | |
| | | | (=70/20/10) | | | | | |
| Example 2 | Cyan/magenta/yellow | P-2 | Phenoxyethyl methacrylate/ | 44500 | 71.7 | 100/108/122 | A | A |
| | | | ethyl methacrylate/ | | | | | |
| | | | methacrylic acid copolymer | | | | | |
| | | | (=50/39/11) | | | | | |
| Example 3 | Cyan/magenta/yellow | P-3 | Phenoxyethyl acrylate/ | 46000 | 77.9 | 125/115/125 | A | A |
| | | | ethyl acrylate/acrylic acid | | | | | |
| | | | copolymer (=45/45/10) | | | | | |
| Example 4 | Cyan/magenta/yellow | P-4 | Phenoxyethyl methacrylate/ | 42300 | 78.2 | 110/115/130 | A | A |
| | | | structure A/ | | | | | |
| | | | ethyl methacrylate/ | | | | | |
| | | | methacrylic acid copolymer | | | | | |
| | | | (=50/5/33/12) | | | | | |
| Comparative | Cyan/magenta/yellow | Benzyl methacrylate/methacrylic | | 44300 | 65.2 | 110/115/130 | B | C |
| example 1 | | acid copolymer (=90/10) | | | | | | |
| Comparative | Cyan/magenta/yellow | Benzyl methacrylate/methacrylic | | 42100 | 130.4 | 105/115/127 | B | D |
| example 2 | | acid copolymer (=80/20) | | | | | | |
| Comparative | Cyan/magenta/yellow | Styrene/methacrylic acid | | 39800 | 65.2 | 140/143/150 | C | C |
| example 3 | | copolymer (=90/10) | | | | | | |
| Example 5 | Cyan/magenta/yellow/black | P-1 | Phenoxyethyl methacrylate/ | 49400 | 65.2 | 95/100/125/ | AA | B |
| | | | methyl methacrylate/ | | | 130 | | |
| | | | methacrylic acid copolymer | | | | | |
| | | | (=70/20/10) | | | | | |
| Example 6 | Cyan/magenta/yellow/black | P-2 | Phenoxyethyl methacrylate/ | 44500 | 71.7 | 100/108/122/ | AA | A |
| | | | ethyl methacrylate/ | | | 132 | | |
| | | | methacrylic acid copolymer | | | | | |
| | | | (=50/39/11) | | | | | |
| Example 7 | Cyan/magenta/yellow/black | P-3 | Phenoxyethyl acrylate/ | 46000 | 77.9 | 125/115/125/ | AA | A |
| | | | ethyl acrylate/acrylic acid | | | 129 | | |
| | | | copolymer (=45/45/10) | | | | | |
| Example 8 | Cyan/magenta/yellow/black | P-4 | Phenoxyethyl methacrylate/ | 42300 | 78.2 | 110/115/130/ | AA | A |
| | | | structure A/ | | | 135 | | |
| | | | ethyl methacrylate/ | | | | | |
| | | | methacrylic acid copolymer | | | | | |
| | | | (=50/5/33/12) | | | | | |

| | | | | | | | |
|---|---|---|---|---|---|---|---|
| Comparative | Cyan/magenta/yellow/black | Benzyl methacrylate/methacrylic | 44300 | 65.2 | 110/115/130/ | B | C |
| example 4 | | acid copolymer (=90/10) | | | 140 | | |
| Comparative | Cyan/magenta/yellow/black | Benzyl methacrylate/methacrylic | 42100 | 130.4 | 105/115/127/ | B | D |
| example 5 | | acid copolymer (=80/20) | | | 143 | | |
| Comparative | Cyan/magenta/yellow/black | Styrene/methacrylic acid | 39800 | 65.2 | 140/143/150/ | C | C |
| example 6 | | copolymer (=90/10) | | | 140 | | |
| Comparative | Cyan/magenta/yellow/black | [Cyan]: Styrene/methacrylic acid | see above | see above | 140/100/125 | B | B |
| example 7 | | copolymer (=90/10) | | | 130 | | |
| | | [Magenta/Yellow/Black]: | | | | | |
| | | Phenoxyethyl | | | | | |
| | | methacrylate/ | | | | | |
| | | methyl methacrylate/ | | | | | |
| | | methacrylic acid copolymer | | | | | |
| | | (=70/20/10) | | | | | |
| Comparative | Cyan/magenta/yellow | [Cyan]: Styrene/methacrylic acid | see above | see above | 140/100/130 | C | C |
| example 8 | | copolymer (=90/10) | | | | | |
| | | [Magenta]: Phenoxyethyl | | | | | |
| | | methacrylate/methyl methacrylate/ | | | | | |
| | | methacrylic acid copolymer | | | | | |
| | | (=70/20/10) | | | | | |
| | | [Yellow]: Benzyl methacrylate/ | | | | | |
| | | methacrylic acid copolymer | | | | | |
| | | (=90/10) | | | | | |

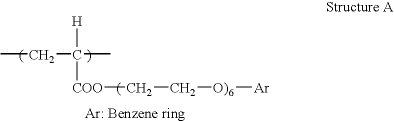

Table 1 shows that in the Examples, scratch resistance of images was high, a failure in ejection directionality caused by adhesion of an aggregate to a head was prevented, image defects of white spots in recorded images were prevented, the amount of the aggregate generated by the mist were fewer, the adhered aggregate was easily removed, and maintenance was reduced and facilitated.

In the Comparative Examples, on the other hand, scratch resistance of images was poor, adhesion of the aggregate to a head was significant, a failure in ejection directionality of ink ejected was not prevented, and image defects of white spots were not prevented.

All publications, patent applications, and technical standards mentioned in this specification are herein incorporated by reference to the same extent as if each individual publication, patent application, or technical standard was specifically and individually indicated to be incorporated by reference.

What is claimed is:

1. An ink set for inkjet recording comprising:
a cyan color aqueous ink composition containing a cyan color pigment, an organic solvent, a neutralizing agent and water,
a magenta color aqueous ink composition containing a magenta color pigment, an organic solvent, a neutralizing agent and water, and
a yellow color aqueous ink composition containing a yellow color pigment, an organic solvent, a neutralizing agent and water,
wherein the cyan color pigment, the magenta color pigment, and the yellow color pigment are each a pigment coated with a water-insoluble resin containing a structural unit represented by the following Formula (I): 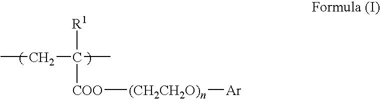
wherein R¹ represents a hydrogen atom or a methyl group, Ar represents an unsubstituted or substituted aromatic ring, and n represents an average repeating number and is from 1 to 6.

2. The ink set for inkjet recording of claim 1, wherein the aromatic ring represented by Ar in Formula (I) is an unsubstituted or substituted benzene ring.

3. The ink set for inkjet recording of claim 1, further comprising a black color aqueous ink composition containing a carbon black, an organic solvent, a neutralizing agent and water, wherein the carbon black is a pigment coated with a water-insoluble resin containing a structural unit represented by Formula (I).

4. The ink set for inkjet recording of claim 1, wherein
the water-insoluble resin comprises a hydrophilic structural unit (A) and a hydrophobic structural unit (B),
the content of aromatic rings in the water-insoluble resin is 20% by mass or less based on the total mass of the water-insoluble resin,
the hydrophobic structural unit (B) includes the structural unit represented by Formula (I),
the content of the hydrophilic structural unit (A) in the water-insoluble resin is 15% by mass or less based on the total mass of the water-insoluble resin, and
the hydrophilic structural unit (A) includes a structural unit derived from (meth)acrylic acid.

5. The ink set for inkjet recording of claim 1, wherein the water-insoluble resin has an acid value of 30 mg KOH/g or more but 100 mg KOH/g or less.

6. The ink set for inkjet recording of claim 1, wherein the pigment coated with a water-insoluble resin containing a structural unit represented by Formula (I) is a pigment coated with the water-insoluble resin by a phase inversion emulsification method.

7. The ink set for inkjet recording of claim 1, wherein at least one of the aqueous ink compositions further comprises a surfactant.
